(19) United States
(12) Patent Application Publication
(10) Pub. No.: US 2025/0015740 A1
(43) Pub. Date: Jan. 9, 2025

(54) MOTOR DRIVING DEVICE AND REFRIGERATION CYCLE-INCORPORATING DEVICE

(71) Applicant: Mitsubishi Electric Corporation, Tokyo (JP)

(72) Inventors: Shoei TSUTSUMI, Tokyo (JP); Shinya TOYODOME, Tokyo (JP); Kazunori HATAKEYAMA, Tokyo (JP)

(21) Appl. No.: 18/689,621

(22) PCT Filed: Nov. 1, 2021
(86) PCT No.: PCT/JP2021/040278

§ 371 Date: Mar. 6, 2024

(51) Int. Cl. H02P 21/20; F25B 49/02; H02P 21/18; H02P 21/22

(52) U.S. Cl. CPC H02P 21/20; F25B 49/025; H02P 21/18; H02P 21/22; F25B 2600/021; F25B 2600/0253; H02P 2207/05

(57) ABSTRACT

A motor driving device includes an inverter that supplies alternating-current voltage to a motor whose speed is variable due to a load variation caused by a compressor, and a control device. The control device includes a frequency estimation unit estimating a frequency estimation value indicating a rotation of the motor, a speed controlling unit generating a first torque current command value based on a deviation between the frequency estimation value and a frequency command value, a load torque estimation unit estimating a load torque applied to the motor, a compensation value calculation unit calculating a torque current compensation value based on the load torque, where the torque current compensation value causes the motor to accelerate in a period including timing of the maximum load torque, and an adding unit generating a second torque current command value based on the first torque current command and torque current compensation values.

### CROSS REFERENCE TO RELATED APPLICATION

This application is a U.S. national stage application of PCT/JP2021/040278 filed on Nov. 1, 2021, the contents of which are incorporated herein by reference.

### TECHNICAL FIELD

The present disclosure relates to a motor driving device for driving a motor, and to a refrigeration cycle-incorporating device.

### BACKGROUND

When the load torque is a load of a compressor and/or the like that varies with a period of one cycle or multiple cycles in mechanical angle, a current supplied from a motor driving device to a motor also varies with pulsation of the load torque. Accordingly, the motor driving device can provide high-efficiency operation by controlling the amplitude value of the current to reduce variation in the amplitude value of the current supplied to the motor. Patent Literature 1 discloses a technology in which a motor control device provides control to reduce to zero the pulsatile component, i.e., the alternating-current (AC) component, of a q-axis current command through integral control, to thus efficiently drive a motor.

### PATENT LITERATURE

Patent Literature 1: Japanese Patent Application Laid-open No. 2016-82636

However, the foregoing conventional technology may indeed reduce loss of copper loss caused by current flowing through the motor, but no consideration is given to efficiency of the entire system including the load of the compressor and/or the like. This presents a problem in that high-efficiency operation may not be achievable in the entire system including the load of the compressor and/or the like.

### SUMMARY

The present disclosure has been made in view of the foregoing, and it is an object of the present disclosure to provide a motor driving device capable of reducing loss occurring in the compressor including a motor, and capable of reducing power consumption in a refrigeration cycle-incorporating device including the compressor.

In order to solve the above problem and achieve the object, a motor driving device according to the present disclosure includes an inverter that supplies an alternating-current voltage having a variable frequency and a variable voltage value to a motor whose speed is variable due to a periodic load variation caused by a load of a compressor, and a control device that controls the inverter. The control device includes a frequency estimation unit that estimates a frequency estimation value indicating a rotation state of the motor, a speed controlling unit that generates a first torque current command value based on a deviation between the frequency estimation value and a frequency command value, a load torque estimation unit that estimates a load torque applied to the motor, a compensation value calculation unit that calculates a torque current compensation value based on the load torque, where use of the torque current compensation value causes the motor to accelerate in a time period including a time when the load torque reaches a maximum value, and an adding unit that generates a second torque current command value based on the first torque current command value and on the torque current compensation value.

A motor driving device according to the present disclosure provides an advantage in capability of reducing loss occurring in the compressor including a motor, and capability of reducing power consumption in a refrigeration cycle-incorporating device including the compressor.

### BRIEF DESCRIPTION OF DRAWINGS

FIG. 1 is a diagram illustrating an example configuration of a refrigeration cycle-incorporating device according to a present embodiment.

FIG. 2 is a cross-sectional view illustrating an overview of a configuration of a compressor included in the refrigeration cycle-incorporating device according to the present embodiment.

FIG. 3 is a diagram schematically illustrating a loss occurring in the compressor in a cross-sectional view taken along 2B-2B line illustrated in FIG. 2 of the compressor included in the refrigeration cycle-incorporating device according to the present embodiment.

FIG. 4 is a diagram schematically illustrating processes of intake, compression, and discharge of a refrigerant performed in a cylinder of the compressor according to the present embodiment.

FIG. 5 is a diagram illustrating a load torque on the motor in the compressor, a compression chamber pressure of the compressor, and a time of loss occurrence in the compressor, according to the present embodiment.

FIG. 6 is a diagram illustrating an example configuration of a motor driving device according to the present embodiment.

FIG. 7 is a diagram illustrating an example configuration of an inverter included in the motor driving device according to the present embodiment.

FIG. 8 is a diagram illustrating an example configuration of a control device included in the motor driving device according to the present embodiment.

FIG. 9 is a diagram illustrating an example configuration of a voltage command value calculation unit included in the control device according to the present embodiment.

FIG. 10 is a diagram illustrating an example of disturbance observer formed in a load torque estimation unit of the motor driving device according to the present embodiment.

FIG. 11 is a diagram illustrating an example of the load torque estimated by the load torque estimation unit, of the compression chamber pressure of the compressor, and of a torque current compensation value generated by a compensation value calculation unit, of the motor driving device according to the present embodiment.

FIG. 12 is a diagram illustrating an example operation of the control device included in the motor driving device according to the present embodiment.

FIG. 13 is a flowchart illustrating an operation of the control device included in the motor driving device according to the present embodiment.

FIG. 14 is a diagram illustrating an example of hardware configuration for implementing the control device included in the motor driving device according to the present embodiment.

### DETAILED DESCRIPTION

A motor driving device and a refrigeration cycle-incorporating device according to an embodiment of the present disclosure will be described in detail below with reference to the drawings.

### Embodiment

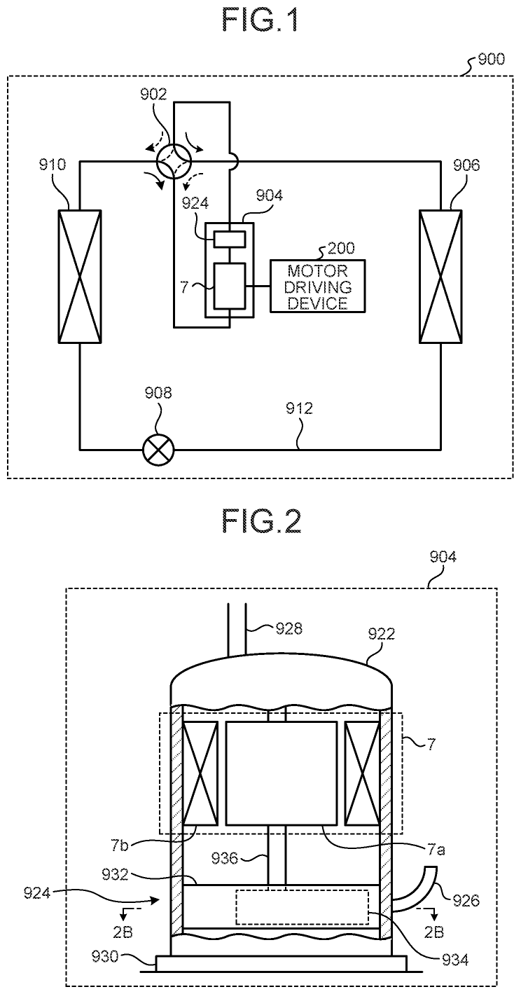

FIG. 1 is a diagram illustrating an example configuration of a refrigeration cycle-incorporating device 900 according to the present embodiment. The refrigeration cycle-incorporating device 900 includes a motor driving device 200. The refrigeration cycle-incorporating device 900 is practicable for products including a refrigeration cycle, such as an air conditioner, a refrigerator, a freezer, and a heat pump water heater. The motor driving device 200 operates the refrigeration cycle-incorporating device 900 by driving a motor 7 incorporated in a compressor 904.

The refrigeration cycle-incorporating device 900 includes the compressor 904 incorporating the motor 7, a four-way valve 902, an indoor heat exchanger 906, an expansion valve 908, and an outdoor heat exchanger 910, which are connected to one another via a refrigerant pipe 912. The compressor 904 includes therein a compression mechanism 924, which compresses a refrigerant, and the motor 7, which operates the compression mechanism 924. The refrigeration cycle-incorporating device 900 is capable of heating and cooling according to a switching operation of the four-way valve 902. The compression mechanism 924 is driven by the motor 7 subjected to variable speed control.

In heating operation, the refrigerant is pressurized and discharged by the compression mechanism 924, flows through the four-way valve 902, the indoor heat exchanger 906, the expansion valve 908, the outdoor heat exchanger 910, and the four-way valve 902, and returns back to the compression mechanism 924 as indicated by the solid line arrows. In cooling operation, the refrigerant is pressurized and discharged by the compression mechanism 924, flows through the four-way valve 902, the outdoor heat exchanger 910, the expansion valve 908, the indoor heat exchanger 906, and the four-way valve 902, and returns back to the compression mechanism 924 as indicated by the broken line arrows.

In heating operation, the indoor heat exchanger 906 acts as a condenser to release heat, while the outdoor heat exchanger 910 acts as an evaporator to absorb heat. In cooling operation, the outdoor heat exchanger 910 acts as a condenser to release heat, while the indoor heat exchanger 906 acts as an evaporator to absorb heat. The expansion valve 908 depressurizes and expands the refrigerant. The compressor 904 is driven by the motor 7 subjected to variable speed control.

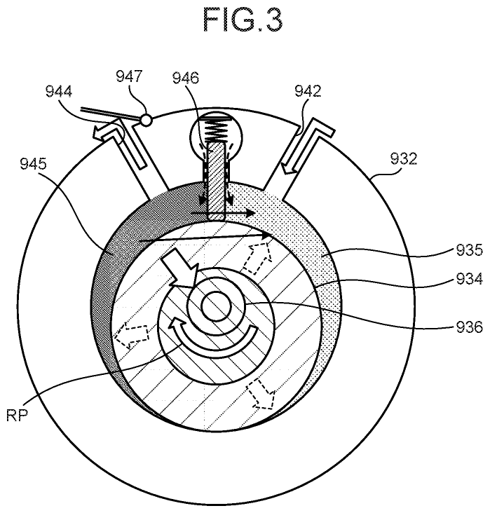

A configuration of the compressor 904 will next be described, which incorporates the motor 7 to be driven by the motor driving device 200. FIG. 2 is a cross-sectional view illustrating an overview of a configuration of the compressor 904 included in the refrigeration cycle-incorporating device 900 according to the present embodiment. FIG. 3 is a diagram schematically illustrating a loss occurring in the compressor 904 in a cross-sectional view taken along 2B-2B line illustrated in FIG. 2 of the compressor 904 included in the refrigeration cycle-incorporating device 900 according to the present embodiment. The compressor 904 is a hermetic rotary compressor, and includes a compressor shell 922, which forms an airtight container, and the compression mechanism 924 disposed inside the compressor shell 922. In the compressor 904, the refrigerant is guided from a suction pipe 926 into the compression mechanism 924, and is discharged from a discharge pipe 928. The compressor shell 922 is supported by a support member 930. The compression mechanism 924 includes a cylinder 932 and a rotary piston 934 disposed in the cylinder 932.

The motor 7 is disposed in the compressor shell 922, and includes a rotor 7a and a stator 7b, which rotatably holds the rotor 7a. The rotor 7a is joined to a shaft 936. The shaft 936 is rotatably held on a frame (not illustrated) by a bearing (not illustrated). This frame is fixed on the compressor shell 922. The shaft 936 is joined to the rotary piston 934. Rotational movement of the rotor 7a of the motor 7 is transmitted through the shaft 936 to the rotary piston 934. In the present embodiment, the speed of the motor 7 changes due to a periodic load variation caused by the load of the compressor 904.

The cylinder 932 has an intake port 942 and a discharge port 944 formed thereon. The cylinder 932 includes a vane 946 therein. The intake port 942 is connected to the suction pipe 926. The discharge port 944 is connected to the discharge pipe 928. Note that FIG. 3 illustrates the intake port 942 and the discharge port 944 conceptually, and the illustrated positions thereof do not necessarily represent the actual positions accurately. The vane 946 is biased toward the center of the cylinder 932 to be able to move in the radial direction of the cylinder 932 while sliding on the circumferential surface of the rotary piston 934.

Rotation of the shaft 936 causes the rotary piston 934 to rotate in the direction indicated by the arrow RP. As a result, in the cylinder 932, evaporated refrigerant is taken from the intake port 942, the refrigerant is compressed, and the refrigerant liquefied by compression is discharged from the discharge port 944. In the cylinder 932, a discharge overshoot loss, which causes a mechanical loss, occurs at a time of opening of a discharge valve 947 as illustrated in FIG. 3. The pressure exerted on the rotary piston 934 varies in the cylinder 932 during the sequence of processes of intake, compression, and discharge. This variation in the pressure causes a variation in a load torque T_{load} applied to the motor 7 in the compressor 904.

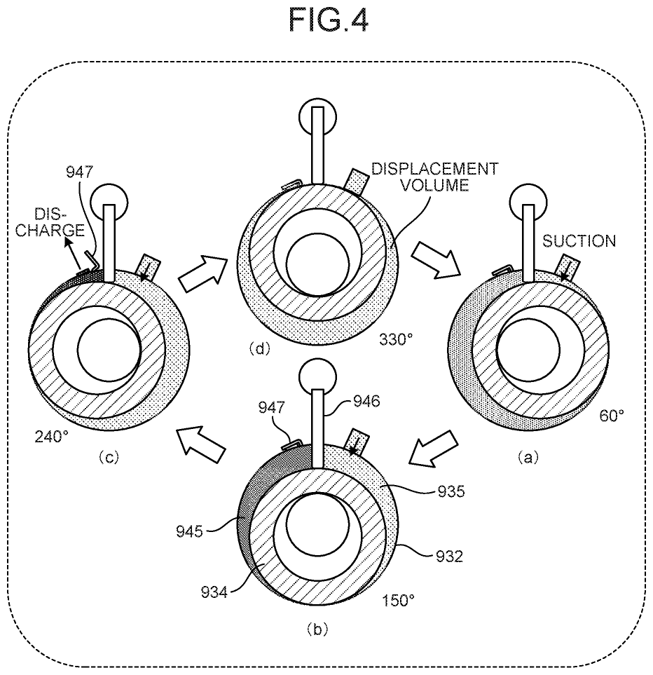

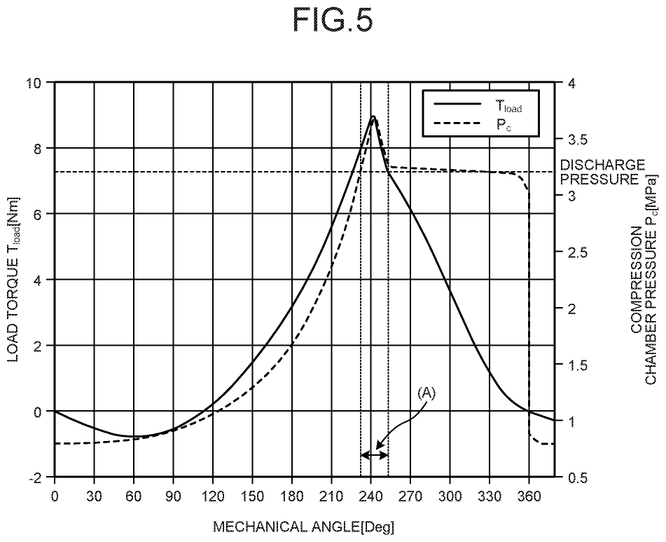

FIG. 4 is a diagram schematically illustrating processes of intake, compression, and discharge of the refrigerant performed in the cylinder 932 of the compressor 904 according to the present embodiment. FIG. 5 is a diagram illustrating the load torque T_{load} on the motor 7 in the compressor 904, a compression chamber pressure P_{c} of the compressor 904, and a time of loss occurrence in the compressor 904, according to the present embodiment. The mechanical angle illustrated in FIG. 4 corresponds to the mechanical angle along the horizontal axis illustrated in FIG. 5. In FIG. 5, the horizontal axis represents the mechanical angle in one cycle of the motor 7, and the vertical axis represents a load torque standard waveform, i.e., the load torque T_{load} on the motor 7, and the compression chamber pressure P_{c} of the compressor 904. In FIG. 4(a), the refrigerant is taken into a suction chamber 935 of the cylinder 932. In the cylinder 932, rotation of the rotary piston 934 in an order of the illustration of FIGS. 4(a), 4(b), 4(c), and 4(d) causes the portion indicated as “displacement volume” to be filled with the refrigerant. At the next time in the state illustrated in FIG. 4(a), a new volume of the refrigerant is taken into the suction chamber 935, and at the same time, the refrigerant filling the portion indicated as “displacement volume” is compressed in a compression chamber 945. In the cylinder 932, rotation of the rotary piston 934 in an order of the illustration of FIGS. 4(b) and 4(c), and opening of the discharge valve 947 causes the compressed refrigerant to be discharged. The time period illustrated in FIG. 4(c) is the time period (A) illustrated in FIG. 5, and is the time when a discharge overshoot loss occurs.

As described above, since the motor 7 is disposed inside the compressor shell 922, the motor 7 is a part of the compressor 904, and the motor 7 can be regarded as a device that drives the compression mechanism 924 of the compressor 904. In the present embodiment, the motor driving device 200 drives the motor 7, and reduces the discharge overshoot loss occurring in the compressor 904 by controlling the motor 7 as described in detail below.

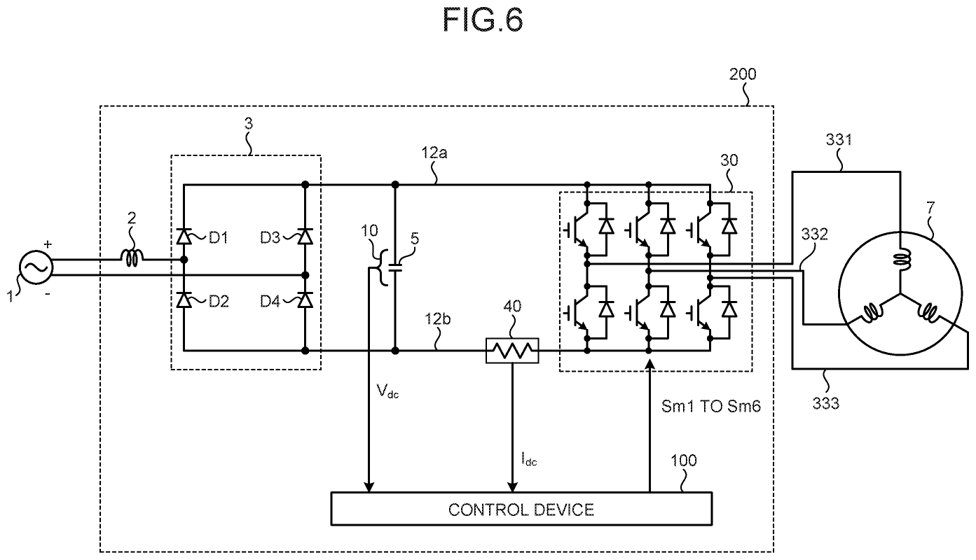

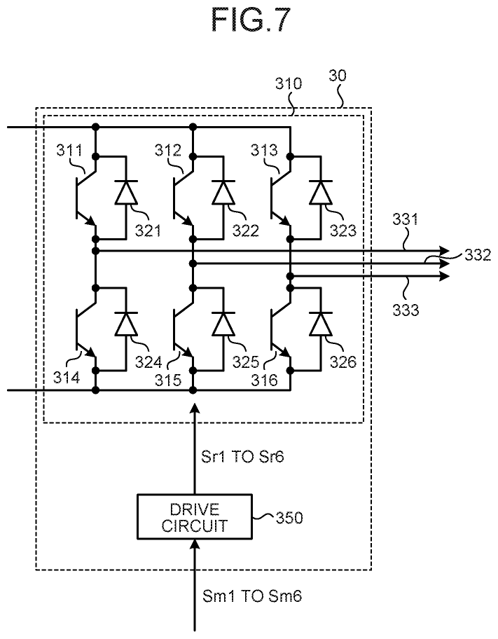

A configuration of the motor driving device 200 will next be described. FIG. 6 is a diagram illustrating an example configuration of the motor driving device 200 according to the present embodiment. FIG. 7 is a diagram illustrating an example configuration of an inverter 30 included in the motor driving device 200 according to the present embodiment. The motor driving device 200 is connected to an alternating-current (AC) power supply 1 and to the motor 7. The motor driving device 200 rectifies an AC voltage supplied from the AC power supply 1, converts the resulting voltage back into an AC voltage, and supplies the resulting AC voltage to the motor 7 to drive the motor 7. The motor driving device 200 includes a reactor 2, a rectification circuit 3, a smoothing capacitor 5, the inverter 30, a bus voltage detection unit 10, a bus current detection unit 40, and a control device 100.

The rectification circuit 3 includes four diodes D1, D2, D3, and D4. The four diodes D1 to D4 are connected to one another in a bridge configuration to form a diode bridge circuit. The rectification circuit 3 rectifies the AC voltage supplied from the AC power supply 1 by the diode bridge circuit formed of the four diodes D1 to D4. The rectification circuit 3 includes input terminals, one of which is connected to the AC power supply 1 via the reactor 2 and another one of which is connected to the AC power supply 1. The rectification circuit 3 also includes output terminals connected across the smoothing capacitor 5.

The smoothing capacitor 5 smooths an output voltage of the rectification circuit 3. The smoothing capacitor 5 includes one electrode connected to a first output terminal of the rectification circuit 3 and to a higher-potential, i.e., positive, direct-current (DC) bus 12a. The smoothing capacitor 5 includes another electrode connected to a second output terminal of the rectification circuit 3 and to a lower potential, i.e., negative, DC bus 12b. The voltage obtained by smoothing by the smoothing capacitor 5 is referred to as bus voltage V_{dc}. The DC buses 12a and 12b are lines connecting together the output terminals of the rectification circuit 3, the electrodes of the smoothing capacitor 5, and the input terminals of an inverter main circuit 310.

The inverter 30 receives a voltage across both ends of the smoothing capacitor 5, i.e., the bus voltage V_{dc}, generates a three-phase AC voltage having a variable frequency and a variable voltage value, and supplies the three-phase AC voltage to the motor 7 via output lines 331 to 333. The inverter 30 includes, as illustrated in FIG. 7, the inverter main circuit 310 and a drive circuit 350. The inverter main circuit 310 includes input terminals connected to the DC buses 12a and 12b. The inverter main circuit 310 includes switching elements 311 to 316. The switching elements 311 to 316 respectively include rectifier elements 321 to 326 for freewheeling purposes, connected in antiparallel with the switching elements 311 to 316.

The drive circuit 350 generates drive signals Sr1 to Sr6 based on pulse width modulation (PWM) signals Sm1 to Sm6 output from the control device 100. The drive circuit 350 controls on and off states of the switching elements 311 to 316 based on the drive signals Sr1 to Sr6. This enables the inverter 30 to supply a three-phase AC voltage having a variable frequency and a variable voltage to the motor 7 via the output lines 331 to 333.

The PWM signals Sm1 to Sm6 are each a signal having a signal level of a logic circuit, that is, a signal having a magnitude from 0 V to 5 V. The PWM signals Sm1 to Sm6 are each a signal whose reference potential is the ground potential of the control device 100. In contrast, the drive signals Sr1 to Sr6 are each a signal having a voltage level required to control a corresponding one of the switching elements 311 to 316, that is, a signal having a magnitude, for example, from −15 V to +15 V. The drive signals Sr1 to Sr6 are each a signal whose reference potential is the potential of the negative terminal, i.e., the emitter terminal, of the corresponding switching element.

The motor 7 is, for example, a three-phase permanent magnet synchronous motor. The present embodiment assumes that the motor 7 drives a load element whose load torque T_{load} periodically varies, specifically, the compressor 904. The motor 7 may be referred to hereinafter as motor.

The bus voltage detection unit 10 detects a voltage across the DC buses 12a and 12b as the bus voltage V_{dc}. The bus voltage detection unit 10 includes, for example, a voltage divider circuit for dividing a voltage using resistors connected in series with each other. The bus voltage detection unit 10 converts, using the voltage divider circuit, the bus voltage V_{dc} detected, into a voltage suitable for performing processing in the control device 100, for example, a voltage of 5 V or below, and outputs that voltage to the control device 100 as a voltage detection signal, which is an analog signal. The voltage detection signal that is output from the bus voltage detection unit 10 to the control device 100 is converted from the analog signal into a digital signal by an analog-to-digital (AD) conversion unit (not illustrated) in the control device 100 for use in internal processing to be performed in the control device 100.

The bus current detection unit 40 includes a shunt resistor inserted on the DC bus 12b. The bus current detection unit 40 detects, using the shunt resistor, a current that is input to the inverter 30, as a DC current I_{dc}. The bus current detection unit 40 outputs the DC current I_{dc} detected to the control device 100 as a current detection signal, which is an analog signal. The current detection signal that is output from the bus current detection unit 40 to the control device 100 is converted from the analog signal into a digital signal by an AD conversion unit (not illustrated) in the control device 100 for use in internal processing to be performed in the control device 100.

The control device 100 generates the PWM signals Sm1 to Sm6 to control the inverter 30. The control device 100 outputs the PWM signals Sm1 to Sm6 to the inverter 30 to thereby control the inverter 30. Specifically, the control device 100 controls the inverter 30 to change an angular frequency ω and the voltage value of an output voltage of the inverter 30.

The angular frequency ω of the output voltage of the inverter 30 is denoted by the character ω, which is the same as the character denoting the angular frequency of the output voltage. The angular frequency ω determines the angular velocity of rotation (hereinafter referred to as rotation angular velocity) of the motor 7 in electrical angle. A rotation angular velocity ωₘ of the motor 7 in mechanical angle is equal to the result of division of the rotation angular velocity ω of the motor 7 in electrical angle by the number of pole pairs Pₘ. Accordingly, a relationship of ωₘ=ω/Pₘ exists between the rotation angular velocity ωₘ of the motor 7 in mechanical angle and the angular frequency ω of the output voltage of the inverter 30. The rotation angular velocity may be referred to hereinafter simply as rotational speed, and the angular frequency may be referred to hereinafter simply as frequency.

The control device 100 generates a magnetizing current command value i_{γ}* based on phase currents iᵤ, iᵥ, and i_{w} flowing to the motor 7, and generates a γ-axis voltage command value V_{γ}* based on the magnetizing current command value i_{γ}*. The control device 100 also calculates a first torque current command value i_{δ}* to match a frequency estimation value ωₑₛₜ of the motor 7 with a frequency command value ωₑ*, calculates a second torque current command value i_{δ}**, which is a corrected value of the first torque current command value i_{δ}*, and generates a δ-axis voltage command value V_{δ}* based on the second torque current command value i_{δ}**. The control device 100 controls the inverter 30 based on the γ-axis voltage command value V_{γ}* and on the δ-axis voltage command value V_{δ}*. As described above, the control device 100 performs control in a rotating coordinate system having a γ-axis and a δ-axis in the present embodiment.

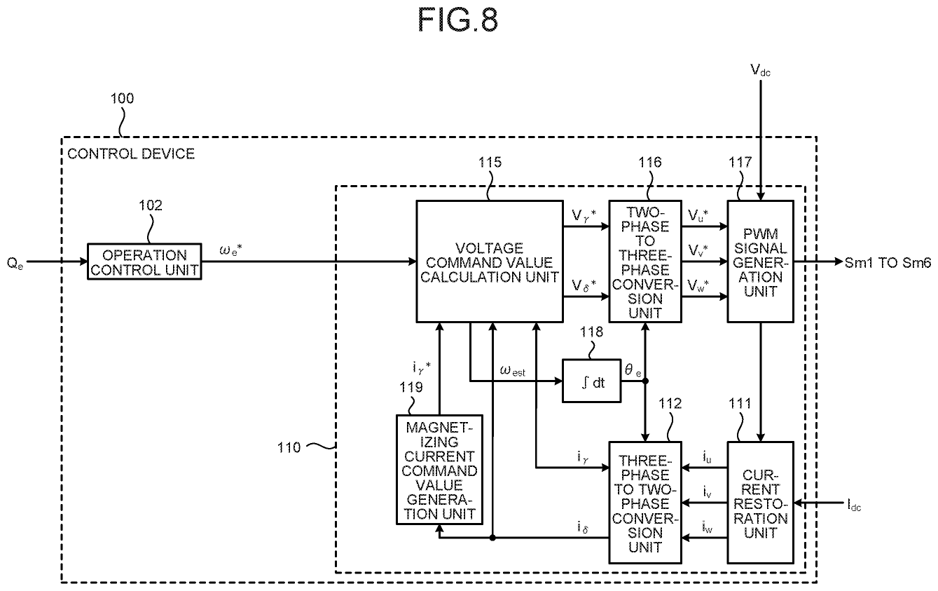

A configuration of the control device 100 will next be described. FIG. 8 is a diagram illustrating an example configuration of the control device 100 included in the motor driving device 200 according to the present embodiment. The control device 100 includes an operation control unit 102 and an inverter control unit 110.

The operation control unit 102 receives command information Qₑ from outside the control device 100, and generates the frequency command value Qₑ* based on the command information Qₑ. The frequency command value ωₑ* can be obtained by multiplication of a rotation angular velocity command value ωₘ*, which is a command value for the rotational speed of the motor 7, by the number of pole pairs Pₘ, that is, by ωₑ*=ωₘ*×Pₘ.

When an air conditioner is controlled as the refrigeration cycle-incorporating device 900, the control device 100 controls operation of components of the air conditioner based on the command information Qₑ. The command information Qₑ is, for example, a temperature detected by a temperature sensor not illustrated, information representing a setting temperature directed from a remote controller, which is an operation unit not illustrated, operation mode selection information, information on instructions to start and stop operation, and/or the like. The operation modes are, for example, heating, cooling, dehumidification, and the like. Note that the operation control unit 102 may be disposed outside the control device 100. That is, the control device 100 may be configured to obtain the frequency command value ωₑ* from outside the control device 100.

The inverter control unit 110 includes a current restoration unit 111, a three-phase to two-phase conversion unit 112, a voltage command value calculation unit 115, a two-phase to three-phase conversion unit 116, a PWM signal generation unit 117, an electrical phase calculation unit 118, and a magnetizing current command value generation unit 119.

The current restoration unit 111 restores the phase currents iᵤ, iᵥ, and i_{w} flowing to the motor 7 based on the DC current I_{dc} detected by the bus current detection unit 40. The current restoration unit 111 can restore the phase currents iᵤ, iᵥ, and i_{w} by sampling the DC current I_{dc} detected by the bus current detection unit 40 at times determined based on the PWM signals Sm1 to Sm6 generated by the PWM signal generation unit 117.

The three-phase to two-phase conversion unit 112 converts the phase currents iᵤ, iᵥ, and i_{w} restored by the current restoration unit 111 into a magnetizing current iᵥ and a torque current i_{δ}, i.e., γδ-axes current values, using an electrical phase θₑ generated by the electrical phase calculation unit 118, which will be described later, where the magnetizing current i_{γ} is a γ-axis current and the torque current i_{δ} is a δ-axis current.

The magnetizing current command value generation unit 119 generates the magnetizing current command value i_{γ}* represented in the foregoing rotating coordinate system. Specifically, the magnetizing current command value generation unit 119 obtains an optimum value of the magnetizing current command value i_{γ}* that will provide a highest efficiency for driving the motor 7, based on the torque current i_{δ}. The magnetizing current command value generation unit 119 outputs, based on the torque current i_{δ}, a value of the magnetizing current command value i_{γ}* that will provide a current phase βₘ that causes an output torque Tₘ to reach a specified or higher value or a maximum value, that is, causes the current value to be a specified or lower value or a minimum value. Note that this example assumes that the magnetizing current command value generation unit 119 obtains the magnetizing current command value i_{γ}* based on the torque current i_{δ}, but this is merely by way of example, and the operation is not limited thereto. A similar advantage is also achievable when the magnetizing current command value generation unit 119 obtains the magnetizing current command value i_{γ}* based on the magnetizing current i_{γ}, the frequency command value ωₑ*, or the like.

The voltage command value calculation unit 115 generates the γ-axis voltage command value V_{γ}* and the δ-axis voltage command value V_{δ}* based on the frequency command value ωₑ* obtained from the operation control unit 102, on the magnetizing current i_{γ} and the torque current i_{δ} obtained from the three-phase to two-phase conversion unit 112, and on the magnetizing current command value i_{γ}* obtained from the magnetizing current command value generation unit 119. In addition, the voltage command value calculation unit 115 estimates the frequency estimation value ωₑₛₜ based on the γ-axis voltage command value V_{γ}*, on the δ-axis voltage command value V_{δ}*, on the magnetizing current i_{γ}, and on the torque current i_{δ}. A specific operation of the voltage command value calculation unit 115 will be described later.

The electrical phase calculation unit 118 calculates the electrical phase θₑ by integrating the frequency estimation value ωₑₛₜ obtained from the voltage command value calculation unit 115.

The two-phase to three-phase conversion unit 116 converts the γ-axis voltage command value V_{γ}* and the δ-axis voltage command value V_{δ}* obtained from the voltage command value calculation unit 115, that is, voltage command values represented in the two-phase coordinate system, into three-phase voltage command values Vᵤ*, Vᵥ*, and V_{w}*, which are output voltage command values represented in the three-phase coordinate system, using the electrical phase θₑ obtained from the electrical phase calculation unit 118.

The PWM signal generation unit 117 generates the PWM signals Sm1 to Sm6 by comparison between the three-phase voltage command values Vᵤ*, Vₙ*, and V_{w}* obtained from the two-phase to three-phase conversion unit 116 and the bus voltage V_{dc} detected by the bus voltage detection unit 10. Note that the PWM signal generation unit 117 can also stop operation of the motor 7 by not outputting the PWM signals Sm1 to Sm6.

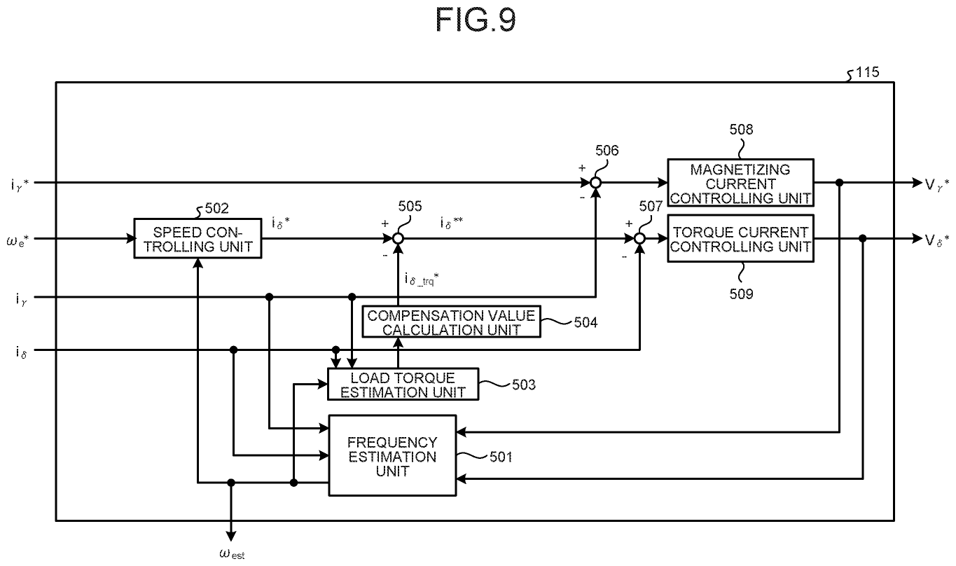

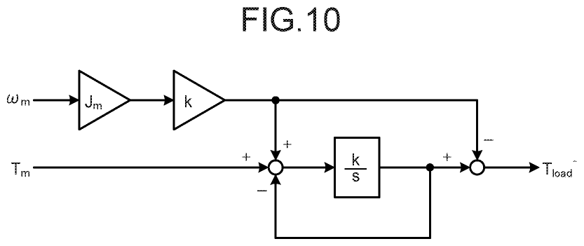

A configuration and an operation of the voltage command value calculation unit 115 will next be described in detail. FIG. 9 is a diagram illustrating an example configuration of the voltage command value calculation unit 115 included in the control device 100 according to the present embodiment. The voltage command value calculation unit 115 includes a frequency estimation unit 501, a speed controlling unit 502, a load torque estimation unit 503, a compensation value calculation unit 504, an adding unit 505, subtraction units 506 and 507, a magnetizing current controlling unit 508, and a torque current controlling unit 509.

The frequency estimation unit 501 estimates the frequency estimation value ωₑₛₜ, which indicates the rotation state of the motor 7. Specifically, the frequency estimation unit 501 estimates the frequency of the voltage applied to the motor 7 based on the magnetizing current i_{γ}, on the torque current i_{δ}, on the γ-axis voltage command value V_{γ}*, and on the δ-axis voltage command value V_{δ}*, and outputs the estimated frequency as the frequency estimation value ωₑₛₜ.

The speed controlling unit 502 generates the first torque current command value i_{δ}* based on the frequency command value ωₑ* obtained from the operation control unit 102 and on the frequency estimation value ωₑₛₜ obtained from the frequency estimation unit 501. The speed controlling unit 502 generates the first torque current command value i_{δ}* to match the frequency estimation value ωₑₛₜ with the frequency command value ωₑ* based on, for example, a difference between the frequency command value ωₑ* and the frequency estimation value ωₑₛₜ using a controller such as a proportional integral (PI) controller.

The load torque estimation unit 503 estimates the load torque T_{load} applied to the motor 7, based on the magnetizing current i_{γ}, on the torque current i_{δ}, and on the frequency estimation value ωₑₛₜ obtained from the frequency estimation unit 501.

The compensation value calculation unit 504 calculates a torque current compensation value i_{δ_trq}* for reducing the discharge overshoot loss occurring in the motor 7, with respect to the load torque T_{load} estimated by the load torque estimation unit 503. A specific method for generating the torque current compensation value i_{δ_trq}* in the compensation value calculation unit 504 will be described later.

The adding unit 505 adds the torque current compensation value i_{δ_trq}* to the first torque current command value i_{δ}*. The adding unit 505 outputs a sum (i_{δ}*+i_{δ_trq}*) obtained by addition of the torque current compensation value i_{δ_trq}* to the first torque current command value i_{δ}*, as the second torque current command value i_{δ}**.

The subtraction unit 506 calculates a difference (i_{γ}*−i_{γ}) of the magnetizing current i_{γ} with respect to the magnetizing current command value i_{γ}*. The subtraction unit 507 calculates a difference (i_{γ}**−i_{δ}) of the torque current i_{δ} with respect to the second torque current command value i_{δ}**.

The magnetizing current controlling unit 508 performs proportional integral operation on the difference (i_{γ}*−i^{γ}) calculated by the subtraction unit 506 to generate the γ-axis voltage command value V_{γ}* for reducing the difference (i_{γ}*−i_{γ}) to near zero. The magnetizing current controlling unit 508 generates the γ-axis voltage command value V_{γ}* in this manner to provide control to match the magnetizing current i_{γ} with the magnetizing current command value i_{γ}*.

The torque current controlling unit 509 performs proportional integral operation on the difference (i_{δ}**−i_{δ}) calculated by the subtraction unit 507 to generate the δ-axis voltage command value V_{δ}* for reducing the difference (i_{δ}**−i_{δ}) to near zero. The torque current controlling unit 509 generates the δ-axis voltage command value V_{δ}* in this manner to provide control to match the torque current i_{δ} with the second torque current command value i_{δ}**.

In the voltage command value calculation unit 115, the proportional gain Kp_γ of the magnetizing current controlling unit 508 is expressed as ω_{cc}·L_{γ}, where ω_{cc} represents a current control response; and the integral gain Ki_γ of the magnetizing current controlling unit 508 is expressed as (R/L_{γ})·Kp_γ using a phase resistance R of the motor 7. In addition, the proportional gain Kp_δ of the torque current controlling unit 509 is expressed as ω_{cc}·L_{δ}, and the integral gain Ki_δ of the torque current controlling unit 509 is expressed as (R/L_{δ})·Kp_δ using the phase resistance R of the motor 7. The voltage command value calculation unit 115 can reduce the time expended by the magnetizing current i_{γ} in following the magnetizing current command value i_{γ}*, and can reduce the time expended by the torque current i_{δ} in following the first torque current command value i_{δ}*, by increasing the value of the current control response ω_{cc}. However, the current control response ω_{cc} is not permitted to be increased indefinitely, but needs to be set to a somewhat low value relative to the control period.

Note that the present embodiment assumes that the motor driving device 200 is configured to restore the phase currents iᵤ, iᵥ, and i_{w} from the DC current I_{dc} flowing through a portion on the input side of the inverter 30, but the configuration is not limited thereto. The motor driving device 200 may include current detectors on the output lines 331, 332, and 333 of the inverter 30 to detect the phase currents iᵤ, iᵥ, and i_{w}. In this case, the motor driving device 200 can use the current values detected by the current detectors instead of the currents restored by the current restoration unit 111.

In the motor driving device 200, the switching elements 311 to 316 of the inverter main circuit 310 are each assumed to be a device such as an insulated gate bipolar transistor (IGBT) or a metal oxide semiconductor field-effect transistor (MOSFET), but any element that can provide switching may be used. Note that when the switching elements 311 to 316 are MOSFETs, a similar advantage is also achievable without including the rectifier elements 321 to 326 for freewheeling purposes connected in antiparallel in the motor driving device 200 because a MOSFET is configured to include a parasitic diode in itself.

The material forming the switching elements 311 to 316 is not limited to silicon (Si), but may also be a wide bandgap semiconductor such as silicon carbide (SiC), gallium nitride (GaN), or diamond to allow loss to be further reduced.

A method will next be described for highly efficiently operating the refrigeration cycle-incorporating device 900 by the motor driving device 200 to reduce discharge overshoot loss occurring in the compressor 904. It is seen in FIGS. 4 and 5 that the motor 7 in the compressor 904 is subjected to a highest load torque T_{load} at phases around 240 degrees in mechanical angle, at which time the discharge valve 947 of the compressor 904 opens. Performing constant-speed control on the motor 7, that is, causing the output torque Tₘ to match the load torque T_{load}, at the time of opening of the discharge valve 947 will undesirably cause a large discharge overshoot loss occurring in the compressor 904.

As such, the motor driving device 200 performs control to accelerate the motor 7 at the time when a discharge overshoot loss will occur. This is understood to enable the motor driving device 200 to highly efficiently operate the compressor 904 while reducing discharge overshoot loss in the compressor 904. The following description is given in terms of a specific control method to be performed in the motor driving device 200, but there is no limitation thereto on the control method for highly efficiently operating the compressor 904 by the motor driving device 200 while reducing discharge overshoot loss in the compressor 904.

A method will first be described for estimating the load torque T_{load} by the load torque estimation unit 503 in the control device 100 of the motor driving device 200. The load torque estimation unit 503 uses a disturbance observer for estimating the load torque T_{load}. The load torque T_{load} can be derived as given by Equation (1) below using equation of motion including the output torque Tₘ, the rotation angular velocity ωₘ, and inertia Jₘ of the load.

$$\begin{matrix}Formula 1 & \\ {T}_{m} - {T}_{load} = {J}_{m} \cdot \frac{d}{dt} ( {ω}_{m} ) & ( 1 )\end{matrix}$$

Thus, Equation (1) can be expressed as an arithmetic expression of the disturbance observer as given by Equation (2), where k [rad/s] represents the pole of the disturbance observer. Note that T_{load} represents the estimated value of the load torque T_{load}, and “s” represents the Laplace operator.

$$\begin{matrix}Formula 2 & \\ {T}_{load} \hat{}= \frac{k}{s + k} ( {T}_{m} - {J}_{m} \cdot s \cdot {ω}_{m} ) & ( 2 )\end{matrix}$$

Thus, expanding Equation (2) as shown by Equation (3) to delete the derivative term of “s” in Equation (2) can form a disturbance observer for estimating the load torque T_{load}, illustrated in FIG. 10. FIG. 10 is a diagram illustrating an example of disturbance observer formed in the load torque estimation unit 503 of the motor driving device 200 according to the present embodiment. The load torque estimation unit 503 can obtain the load torque estimation value T_{load} by using the disturbance observer illustrated in FIG. 10, where the load torque estimation value T_{load} is the estimated value of the load torque T_{load}.

$$\begin{matrix}Formula 3 & \\ {T}_{load} \hat{}= \frac{k}{s + k} ( {T}_{m} - k \cdot {J}_{m} \cdot {ω}_{m} ) - k \cdot {J}_{m} \cdot {ω}_{m} & ( 3 )\end{matrix}$$

Note that the output torque Tₘ is expressed by Equation (4). In Equation (4), Pₘ is the number of pole pairs of the motor 7, φ_{f} is the magnetic flux of the motor 7, L_{d} is the d-axis inductance, and L_{q} is the q-axis inductance. The load torque estimation unit 503 is capable of calculating the output torque Tₘ by, for example, storing these parameters in advance. The load torque estimation unit 503 outputs the load torque estimation value T_{load} to the compensation value calculation unit 504 as the load torque T_{load} obtained by estimation.

$$\begin{matrix}Formula 4 & \\ {T}_{m} = {P}_{m} \cdot {φ}_{f} \cdot {i}_{δ} + {P}_{m} ( {L}_{d} - {L}_{q} ) \cdot {i}_{γ} \cdot {i}_{δ} & ( 4 )\end{matrix}$$

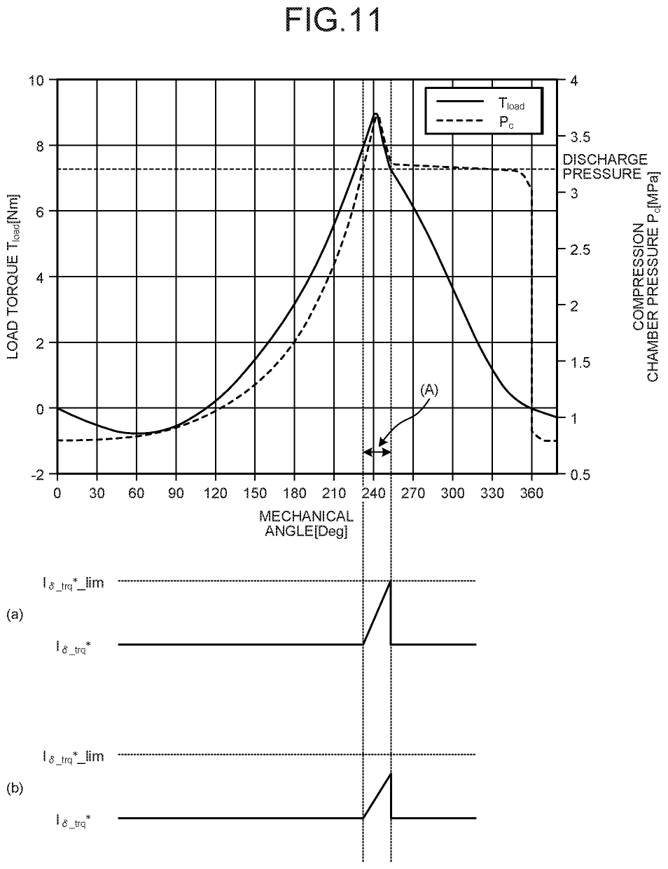

FIG. 11 is a diagram illustrating an example of the load torque T_{load} estimated by the load torque estimation unit 503, of the compression chamber pressure P_{c} of the compressor 904, and of the torque current compensation value i_{δ_trq}* generated by the compensation value calculation unit 504, in the motor driving device 200 according to the present embodiment. When the load torque estimation unit 503 has estimated a waveform of the load torque T_{load} as depicted in FIG. 11, the compensation value calculation unit 504 generates and outputs the torque current compensation value i_{δ_trq}* illustrated in graph (a) or (b) in the lower part. In the control device 100, the adding unit 505 adds the torque current compensation value i_{δ_trq}* to the first torque current command value i_{δ}* to generate the second torque current command value i_{δ}**.

The control device 100 adds the torque current compensation value i_{δ_trq}* in the time period (A) including the time when the load torque T_{load} reaches the peak and the discharge valve 947 opens as illustrated in FIG. 11, to thus drive the motor 7, hence the compressor 904, to accelerate rapidly.

Note that the limit value of the torque current compensation value i_{δ_trq}* generated by the compensation value calculation unit 504 is expressed by Equation (5). That is, the limit value i_{δ_trq}*_lim of the torque current compensation value i_{δ_trq}* is a value obtained by subtraction of the first torque current command value i_{δ}* from a limit value i_{δ}_lim* of the overall torque current i_{δ}.

$${i}_{δ\_ trq} * \_lim = {i}_{δ} \_lim * - {i}_{δ} * \qquad ( 5 )$$

The torque current compensation value i_{δ_trq}* may be almost equal to the limit as illustrated in graph (a) of FIG. 11, or leave a certain amount of margin as illustrated in graph (b) of FIG. 11. In addition, there is no particular limitation on the slope of increase in the torque current compensation value i_{δ_trq}*. The foregoing enables the control device 100 to reduce the time period of occurrence of discharge overshoot loss, and to thus reduce discharge overshoot loss.

Although generation of a value of the torque current compensation value i_{δ_trq}* that will stop the motor 7 is inappropriate, no problem is presented even when the control device 100 adjusts the first torque current command value i_{δ}* so that the speed follows a speed command value on average during a time period outside the time period (A) of FIG. 11.

The control device 100 should set the timing of switching of the torque current compensation value i_{δ_trq}* in the time period (A) illustrated in FIG. 11 taking into account factors such as control delay in a controller (not illustrated). Such timing is accordingly not limited to the timing illustrated in FIG. 11.

Note that, in the motor driving device 200, the mechanical loss varies with factors such as the value of the torque current compensation value i_{δ_trq}* and the time period during which the value of the torque current compensation value i_{δ_trq}* is increased and decreased, depending on the type of the refrigerant used in the refrigeration cycle-incorporating device 900 including the compressor 904 and compressed by the compressor 904, or the like. Accordingly, the optimum value of the torque current compensation value i_{δ_trq}* differs depending on conditions.

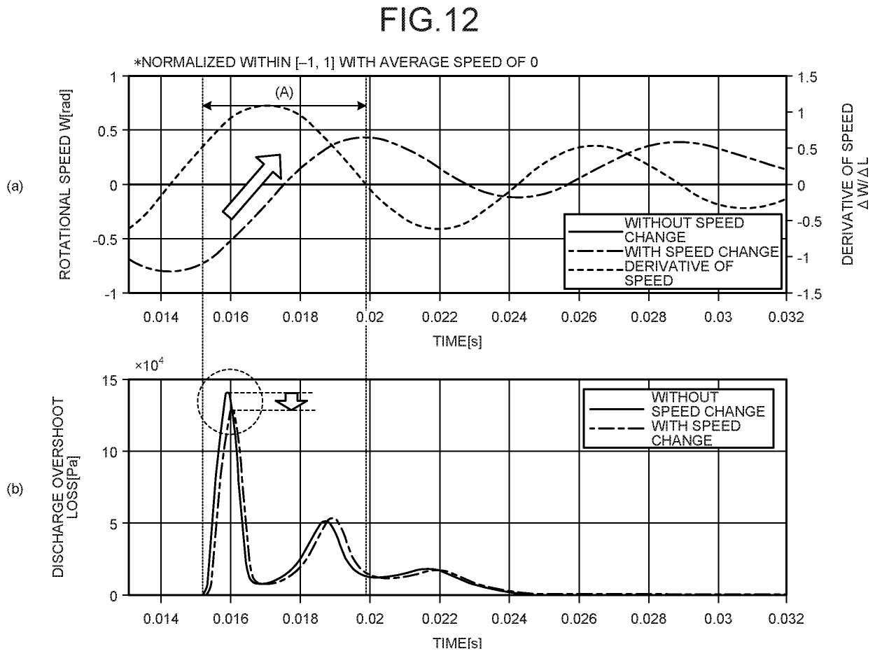

FIG. 12 is a diagram illustrating an example operation of the control device 100 included in the motor driving device 200 according to the present embodiment. FIG. 12(a) illustrates rotational speeds of the motor 7 when the rotational speed of the motor 7 is varied as in the present embodiment and when the rotational speed of the motor 7 is not varied, given as a comparative example. FIG. 12(a) also illustrates a component obtained by differentiating the rotational speed when the rotational speed of the motor 7 is varied as in the present embodiment. FIG. 12(b) illustrates discharge overshoot loss when the rotational speed of the motor 7 is varied as in the present embodiment and discharge overshoot loss when the rotational speed of the motor 7 is not varied, given as a comparative example. In FIGS. 12(a) and 12(b), the horizontal axes represent time. The control device 100 adds the torque current compensation value i_{δ_trq}* in the time period (A) of FIGS. 11 and 12 to rapidly accelerate the compressor 904, and can thus provide an advantage to reduce discharge overshoot loss as illustrated in FIG. 12(b). Note that the refrigerant for use in the refrigeration cycle-incorporating device 900 according to the present embodiment is not particularly limited, and may be a refrigerant commonly known as old refrigerant or a new refrigerant. Old refrigerants include refrigerants such as, for example, R-410 and R-32. New refrigerants include refrigerants such as, for example, trifluoroethylene (HFO-1123), trifluoromethane (CF-31), and propane (R-290).

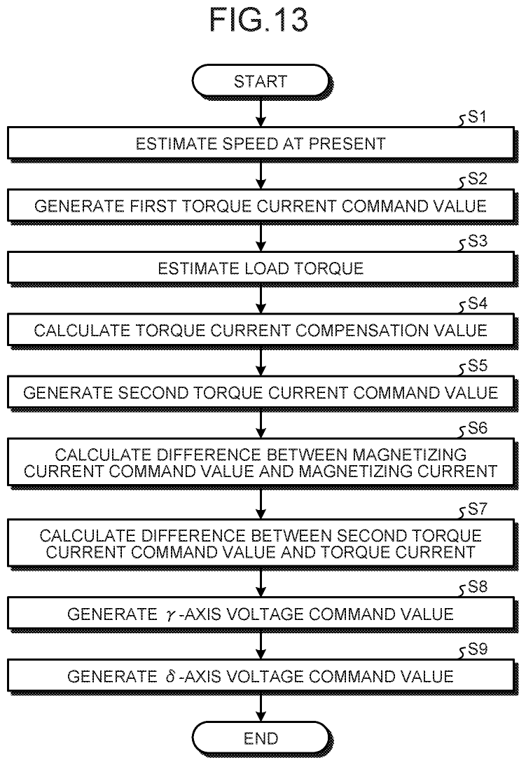

An operation of the control device 100 included in the motor driving device 200 will next be described with reference to a flowchart. FIG. 13 is a flowchart illustrating an operation of the control device 100 included in the motor driving device 200 according to the present embodiment. Specifically, the flowchart illustrated in FIG. 13 illustrates an operation of the voltage command value calculation unit 115.

In the control device 100, the frequency estimation unit 501 estimates the frequency estimation value ωₑₛₜ, which is the speed of the motor 7 at present, indicating the rotation state (step S1). The speed controlling unit 502 generates the first torque current command value i_{δ}* based on a deviation between the frequency estimation value West and the frequency command value ωₑ* of the motor 7 (step S2). The load torque estimation unit 503 estimates the load torque T_{load} applied to the motor 7 (step S3). The compensation value calculation unit 504 calculates a value of the torque current compensation value i_{δ_trq}* that causes acceleration of the motor 7 at least once during one cycle of the motor 7 in mechanical angle based on the load torque T_{load} (step S4). The adding unit 505 generates the second torque current command value i_{δ}** based on the first torque current command value i_{δ}* and on the torque current compensation value i_{δ_trq}* (step S5). The subtraction unit 506 calculates a difference (i_{γ}*−i_{γ}) between the magnetizing current command value i_{γ}* and the magnetizing current i_{γ} (step S6). The subtraction unit 507 calculates a difference (i_{δ}**−i_{δ}) between the second torque current command value i_{δ}** and the torque current is (step S7). The magnetizing current controlling unit 508 generates the γ-axis voltage command value V_{γ}* based on the difference (i_{γ}*−i_{γ}) calculated by the subtraction unit 506 (step S8). The torque current controlling unit 509 generates the δ-axis voltage command value V_{δ}* based on the difference (i_{δ}**−i_{δ}) calculated by the subtraction unit 507 (step S9).

In addition, the compensation value calculation unit 504 calculates a value of the torque current compensation value i_{δ_trq}* that causes acceleration of the motor 7 in a time period including the time when the load torque T_{load} reaches a maximum value to reduce the discharge overshoot loss in the compressor 904. The time period including the time when the load torque T_{load} reaches a maximum value is the time period (A) illustrated in FIG. 11.

For example, the compensation value calculation unit 504 calculates the torque current compensation value i_{δ_trq}* to cause the motor 7 to accelerate when the load torque T_{load} exceeds a threshold. In this operation, the compensation value calculation unit 504 calculates the threshold based on the load torque T_{load} obtained by estimation (hereinafter, simply estimated) in a previous or earlier control operation(s). The compensation value calculation unit 504 may use either the last value of the load torque T_{load} or an average value of values of the load torque T_{load} in multiple control operations including the last control operation, as the load torque T_{load} estimated in a previous or earlier control operation(s).

Note that the compensation value calculation unit 504 may calculate the torque current compensation value i_{δ_trq}* to cause the motor 7 to accelerate, based on a mechanical angle corresponding to the load torque T_{load} that has been estimated. Alternatively, the compensation value calculation unit 504 may calculate the torque current compensation value i_{δ_trq}* to cause the motor 7 to accelerate, based on the above threshold and on a mechanical angle corresponding to the load torque T_{load} that has been estimated. In addition, the compensation value calculation unit 504 may maintain the magnitude of the acceleration constant or change the magnitude of the acceleration depending on the load torque T_{load} that has been estimated, during the time period of causing the motor 7 to accelerate.

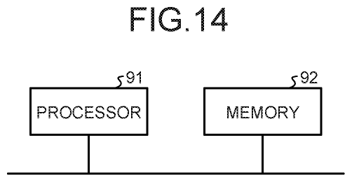

A hardware configuration of the control device 100 included in the motor driving device 200 will next be described. FIG. 14 is a diagram illustrating an example of hardware configuration for implementing the control device 100 included in the motor driving device 200 according to the present embodiment. The control device 100 is implemented by a processor 91 and a memory 92.

The processor 91 is a central processing unit (CPU) (also known as a processing unit, a computing unit, a microprocessor, a microcomputer, a processor, and a digital signal processor (DSP)), or a system large scale integration (LSI). Examples of the memory 92 include non-volatile and volatile semiconductor memories such as a random access memory (RAM), a read-only memory (ROM), a flash memory, an erasable programmable read-only memory (EPROM), and an electrically erasable programmable read-only memory (EEPROM) (registered trademark). The memory 92 is not limited to these, but may also be a magnetic disk, an optical disk, a compact disc, a MiniDisc, or a digital versatile disc (DVD).

As described above, according to the present embodiment, the control device 100 in the motor driving device 200 included in the refrigeration cycle-incorporating device 900 estimates the load torque T_{load} on the motor 7, and controls the torque current command value to cause the motor 7 to accelerate in a time period including the time corresponding to the mechanical angle when the load torque T_{load} reaches a maximum value to thereby reduce the discharge overshoot loss. This enables the motor driving device 200 to reduce loss occurring in the compressor 904 including the motor 7, and to thus reduce power consumption in the refrigeration cycle-incorporating device 900 including the compressor 904. When the compressor 904 included in the refrigeration cycle-incorporating device 900 is a rotary compressor, the motor driving device 200 can reduce mechanical loss caused by overshoot loss occurring at the time of opening of the discharge valve 947, and can thus provide high-efficiency operation of the refrigeration cycle-incorporating device 900.

Note that the present embodiment has been described with respect to high-efficiency operation, using an example in which the compressor 904 is a single rotary compressor, but the compressor 904 is not limited thereto. The motor driving device 200 can perform the control operation according to the present embodiment described above also when the compressor 904 used in the refrigeration cycle-incorporating device 900 is a twin rotary compressor, a scroll compressor, or the like. In such cases, the compensation value calculation unit 504 calculates the torque current compensation value i_{δ_trq}* that will involve acceleration operation of the motor 7 depending on the number of times of load variations occurring during one revolution of the motor 7. The motor driving device 200 is applicable to a control system including a speed controller and a current controller in control means for driving the motor 7.

As described above, the motor driving device 200 of the present embodiment is suitable for the refrigeration cycle-incorporating device 900 of a type that switches windings of the motor 7 while using. The refrigeration cycle-incorporating device 900 has been herein described in the context of an air conditioner by way of example. The application of the present embodiment is however not limited thereto, and the present embodiment is also applicable to, for example, a refrigerator, a freezer, a heat pump water heater, and the like.

The configurations described in the foregoing embodiment are merely examples. These configurations may be combined with a known other technology, and configurations of different embodiments may be combined together. Moreover, part of such configurations may be omitted and/or modified without departing from the spirit thereof.

1. A motor driving device comprising:
an inverter supplying an alternating-current voltage to a motor, a frequency and a voltage value of the alternating-current voltage being variable, the speed of the motor being variable due to a periodic load variation caused by a load of a compressor; and
a control device controlling the inverter, wherein
the control device comprises
frequency estimation circuitry estimating a frequency estimation value, the frequency estimation value indicating a rotation state of the motor,
speed controlling circuitry generating a first torque current command value on a basis of a deviation between the frequency estimation value and a frequency command value,
load torque estimation circuitry estimating a load torque applied to the motor,
compensation value calculation circuitry calculating a torque current compensation value on a basis of the load torque, use of the torque current compensation value causing the motor to accelerate in a time period, the time period including a time when the load torque reaches a maximum value, and
adding circuitry generating a second torque current command value on a basis of the first torque current command value and the torque current compensation value, wherein
the compensation value calculation circuitry calculates a threshold based on the load torque obtained by estimation in a previous control operation, and calculates the torque current compensation value to cause the motor to accelerate when the load torque exceeds the threshold.

2. (canceled)

3. The motor driving device according to claim 1, wherein
the compensation value calculation circuitry calculates the torque current compensation value that will involve acceleration operation of the motor depending on a number of times of load variations occurring during one revolution of the motor.

4. The motor driving device according to claim 1, wherein
the compressor is included in a refrigeration cycle-incorporating device that uses a refrigerant, and the compressor compresses the refrigerant, the refrigerant being trifluoroethylene, trifluoromethane, or propane.

5. A refrigeration cycle-incorporating device comprising the motor driving device according to claim 1.

6. The motor driving device according to claim 3, wherein
the compressor is included in a refrigeration cycle-incorporating device that uses a refrigerant, and the compressor compresses the refrigerant, the refrigerant being trifluoroethylene, trifluoromethane, or propane.

7. A refrigeration cycle-incorporating device comprising the motor driving device according to claim 3.

8. A refrigeration cycle-incorporating device comprising the motor driving device according to claim 4.

9. A refrigeration cycle-incorporating device comprising the motor driving device according to claim 6.
